(19) United States
(12) Patent Application Publication
(10) Pub. No.: US 2013/0014082 A1
(43) Pub. Date: Jan. 10, 2013

(54) METHOD OF CONFIGURING BUSINESS LOGIC SUPPORTING MULTI-TENANCY

(75) Inventors: Sung Joo Kang, Daejeon (KR); Jihyun Lee, Daejeon (KR)

(73) Assignee: Electronics and Telecommunications Research Institute, Daejon (KR)

(21) Appl. No.: 13/608,719

(22) Filed: Sep. 10, 2012

(30) Foreign Application Priority Data
Jul. 10, 2011 (KR) 10-2011-0102600

(51) Int. Cl. G06F 9/44

(52) U.S. Cl. 717/121

(57) ABSTRACT

The present invention relates to a method of configuring business logic supporting multi-tenancy. The method includes the steps of an application execution platform storing business logic, received from a service development tool, in a metadata storage unit as a common business logic, the application execution platform determining whether a modified business logic has been received from the service configuration tool of a tenant and if the modified business logic is determined to have been received, the application execution platform storing the modified business logic in the metadata storage unit as business logic dedicated to the tenant. In accordance with the present invention, since each of tenants who have subscribed to service can configure business logic for application service through the service configuration tool, each tenant may modify and used business logic in a desired form.

### CROSS-REFERENCE TO RELATED APPLICATION

The present application claims priority under 35 U.S.C 119(a) to Korean Application No. 10-2011-0102600, filed on Oct. 7, 2011, in the Korean Intellectual Property Office, which is incorporated herein by reference in its entirety set forth in full.

### BACKGROUND OF THE INVENTION

Exemplary embodiments of the present invention relate to a method of configuring business logic supporting multi-tenancy, and more particularly, to a method of configuring business logic supporting multi-tenancy, in which a specific tenant may modify business logic without affecting the use of service by other tenants in an on-line application providing environment supporting multi-tenancy.

As a cloud computing system in which data may be stored and used through a server on the Internet is recently proliferating, there is a tendency that services providing on-line applications, such as Software as a Service (SaaS), are increased.

In enterprise applications based on SaaS, such as Enterprise Resource Planning (ERP), Customer Relationship Management (CRM), and Groupware, an enterprise who has subscribed to an application service is called a tenant. From the viewpoint of a service provider, to provide service to a plurality of tenants through a service instance is called multi-tenancy.

In this multi-tenancy service environment, since business logic required by each of tenants is commonly different. Thus, it is necessary to modify business logic for application service according to the requirements of a specific tenant without affecting service provided to other tenants.

In a conventional multi-tenancy service environment, a developer who has developed an application may generate and edit business logic for application service.

This method is, however, problematic in that it is difficult to modify business logic after service is developed and distributed because the developer cannot modify business logic for application service which is now being used by each tenant.

Furthermore, there is a problem in that a service provider requires a lot of costs in maintaining and repairing service because a developer must be involved in modifying business logic for application service.

### SUMMARY OF THE INVENTION

An embodiment of the present invention relates to a method of configuring business logic supporting multi-tenancy, in which a specific tenant who has subscribed to service may modify business logic for application service without affecting the use of service by other tenants in an on-line application providing environment supporting multi-tenancy.

In one embodiment, a method of configuring business logic supporting multi-tenancy includes an application execution platform storing business logic, received from a service development tool, in a metadata storage unit as a common business logic; the application execution platform determining whether a modified business logic has been received from the service configuration tool of a tenant; and if the modified business logic is determined to have been received, the application execution platform storing the modified business logic in the metadata storage unit as business logic dedicated to the tenant.

In the step of storing the modified business logic as business logic dedicated to the tenant, the business logic dedicated to the tenant is stored separately from the common business logic.

In the step of storing the modified business logic as business logic dedicated to the tenant, the business logic dedicated to the tenant is stored based on a tenant ID of the tenant.

The method further includes the application execution platform determining whether service execution input to request the execution of service has been received from an application; if the service execution input is determined to have been received, the application execution platform extracting business logic from the metadata storage unit based on the service execution input; and the application execution platform executing the service by performing the extracted business logic, after the step of storing the modified business logic as business logic dedicated to the tenant.

The service execution input includes a tenant ID of the tenant and a Uniform Resource Location (URL) for fetching the business logic stored in the metadata storage unit.

In the step of extracting the business logic from the metadata storage unit based on the service execution input, the application execution platform extracts the common business logic or the business logic dedicated to the tenant based on the tenant ID.

In the step of executing the service by performing the extracted business logic, the application execution platform executes the service by querying an application database about a Structured Query Language (SQL) of the extracted business logic.

### BRIEF DESCRIPTION OF THE DRAWINGS

The above and other aspects, features and other advantages will be more clearly understood from the following detailed description taken in conjunction with the accompanying drawings, in which:

FIG. 1 is a block diagram of an apparatus for performing a method of configuring business logic supporting multi-tenancy according to an embodiment of the present invention.

FIG. 2 is a flowchart illustrating a process in which a service development tool generates business logic in the method of configuring business logic supporting multi-tenancy according to an embodiment of the present invention.

FIG. 3 is a flowchart illustrating a process in which a service configuration tool modifies business logic in the method of configuring business logic supporting multi-tenancy according to an embodiment of the present invention.

FIG. 4 is a flowchart illustrating an operation of the method of configuring business logic supporting multi-tenancy according to an embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

Business logic relates to a business processing flow and means a routine for performing the input, modification, query, and processing of data which is necessary for business.

The business logic is fetched in the form of a Uniform Resource Location (URL) in a User Interface (UI) of application service, and the business logic executes specific logic and transfers a result of the logic execution to the UI.

The present invention is described in detail below.

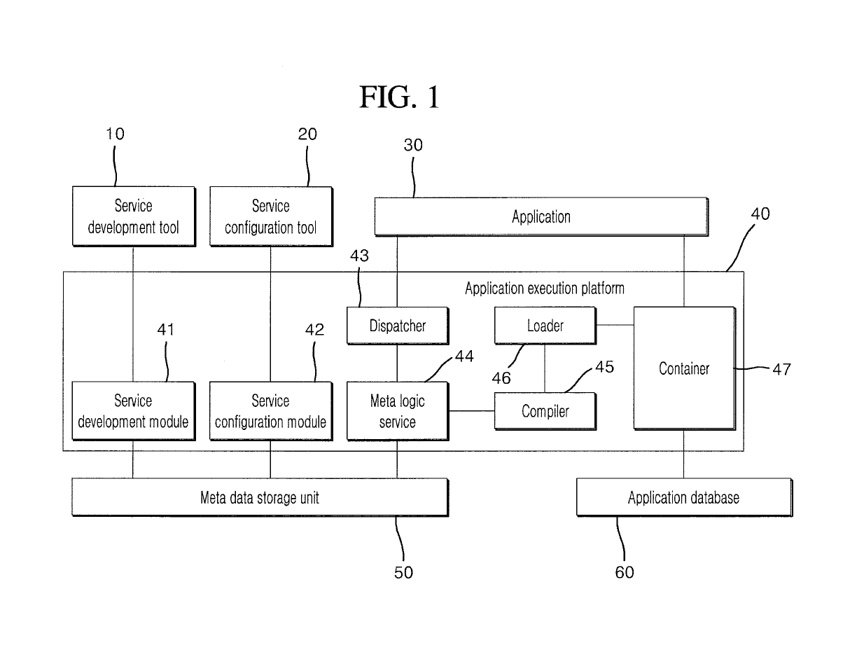

FIG. 1 is a block diagram of an apparatus for performing a method of configuring business logic supporting multi-tenancy according to an embodiment of the present invention.

As shown in FIG. 1, the apparatus for performing a method of configuring business logic supporting multi-tenancy according to the embodiment of the present invention includes a service development tool 10, a service configuration tool 20, an application 30, an application execution platform 40, and a metadata storage unit 50.

The service development tool 10 is a tool which is used for a developer to develop business logic for application service. The service development tool 10 transfers business logic, defined based on logic generation input inputted by a developer, to the application execution platform 40.

Here, input parameters transferred together with a URL for fetching the business logic, a Structured Query Language (SQL) for executing the business logic, and output parameters transferred as a result of output may be defined based on the logic generation input for defining the business logic.

The service configuration tool 20 enables a specific tenant who has subscribed to service to modify business logic for application service. The service configuration tool 20 transfers business logic, modified based on logic configuration input inputted by each tenant, to the application execution platform 40.

Here, input parameters transferred together with a URL, an SQL for executing the business logic, and output parameters transferred as a result of output may be newly defined based on the logic configuration input for modifying the business logic.

The application 30 refers to SaaS application service provided to a tenant who has subscribed to service. The application 30 transfers service execution input, inputted by each tenant, to the application execution platform 40.

Here, the service execution input to request the execution of service may include a tenant ID assigned to identify a tenant who has subscribed to the service, a URL for fetching business logic, and so on.

Meanwhile, the service development tool 10, the service configuration tool 20, and the application 30 may be implemented in the form of a web application which is operated through a web browser.

The application execution platform 40 is a platform for providing some resources or service necessary for the operations of the service development tool 10, the service configuration tool 20, and the application 30 and may be implemented in the form of a web application execution engine.

That is, the service development tool 10, the service configuration tool 20, and the application 30 may have a client and server relationship with the application execution platform 40.

The application execution platform 40 includes a service development module 41, a service configuration module 42, a dispatcher 43, meta logic service 44, a compiler 45, a loader 46, and a container 47.

The service development module 41 stores business logic, received from the service development tool 10, in the metadata storage unit 50 as a common business logic.

That is, business logic developed by a developer using the service development tool 10 is stored as a common business logic, and service using the common business logic is basically provided to tenants who have subscribed to the service.

The service configuration module 42 stores a modified business logic, received from the service configuration tool 20, in the metadata storage unit 50 as business logic dedicated to a relevant tenant.

That is, business logic modified by a tenant using the service configuration tool 20 is stored as business logic dedicated to the relevant tenant, and service using the dedicated business logic may be provided to the relevant tenant.

When service execution input to request the execution of service is received from the application 30, the dispatcher 43, the meta logic service 44, the compiler 45, the loader 46, and the container 47 of the application execution platform 40 may extract a common business logic or dedicated business logic from the metadata storage unit 50 and execute the requested service based on the service execution input.

More particularly, when service execution input is received from the application 30, the dispatcher 43 analyzes a requested URL and transfers a result of the analysis and a tenant ID to the meta logic service 44.

In response thereto, the meta logic service 44 extracts a common business logic codes or a dedicated business logic codes, matching with the tenant ID, from the metadata storage unit 50 and transfers them to the compiler 45.

In response thereto, the compiler 45 complies the received codes in the form of a class and transfers the class to the loader 46. The loader 46 loads the class onto the container 47.

The class loaded onto the container 47 executes the SQL of business logic, and the SQL is processed after being queried in an application database 60. A processed result is transferred to the application 30 in the form of output parameters, and thus the requested service is executed.

The metadata storage unit 50 is a database accessible to the application execution platform 40 for storing and processing data. A common business logic and business logic dedicated to each tenant may be stored in the metadata storage unit 50.

Here, the common business logic and the business logic dedicated to each tenant are separately stored in different rows on the metadata storage unit 50.

As described above, since the common business logic and the business logic dedicated to each tenant are separately stored in different positions on the metadata storage unit 50, the modification of business logic does not influence service provided to other tenants and the business logic may be modified even after service is distributed, although a specific tenant modifies the business logic.

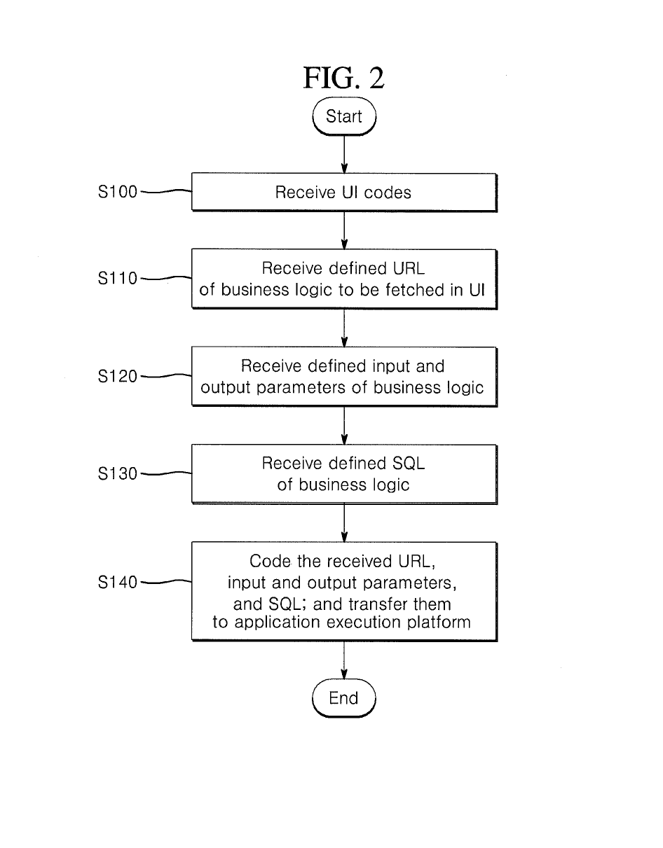

FIG. 2 is a flowchart illustrating a process in which the service development tool 10 generates business logic in the method of configuring business logic supporting multi-tenancy according to an embodiment of the present invention.

First, the service development tool 10 receives UI codes from a developer at step S100.

The inputted and generated UI does not have logic, but has only a layout. Therefore, business logic must be fetched in order to generate data to be inputted to the UI.

Accordingly, the service development tool 10 receives a URL for business logic to be fetched in the UI from the developer at step S110.

Next, the service development tool 10 sequentially receives input parameters inputted to the business logic, output parameters outputted after the business logic is executed, and the SQL of the business logic at steps S120 and S130.

The service development tool 10 generates business logic codes by programming and coding the URL, the input and output parameters, and the SQL received as described above and transfers the business logic codes to the application execution platform 40 at step S140.

In response thereto, the application execution platform 40 stores the received business logic codes in the metadata storage unit 50 as a common business logic.

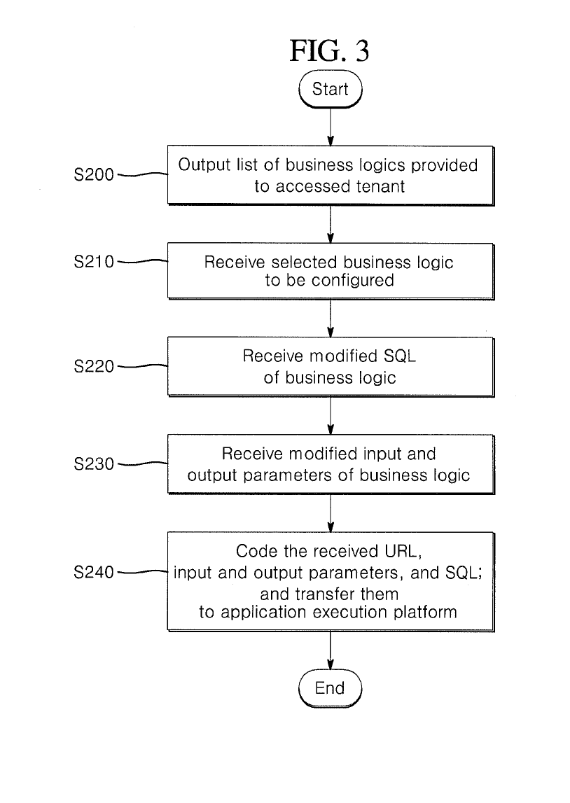

FIG. 3 is a flowchart illustrating a process in which the service configuration tool 10 modifies business logic in the method of configuring business logic supporting multi-tenancy according to an embodiment of the present invention.

First, the service configuration tool 20 outputs a list of business logics which are being provided to a tenant now accessed at step S200.

Here, if the tenant has not modified business logic, the list of business logics may include only a common business logic. If the tenant has configured a dedicated business logic by modifying a common business logic, the list of business logics may include the common business logic and the business logic dedicated to the tenant.

Next, the service configuration tool 20 receives business logic which will be configured and which has been selected by the tenant, from among the list of business logics at step S210.

When the business logic to be configured is selected, the service configuration tool 20 receives a modified SQL at step S220.

When the SQL is modified, input parameters inputted to the business logic and output parameters outputted after the business logic is executed must be also modified. Therefore, the service configuration tool 20 receives modified input and output parameters at step S230.

The service configuration tool 20 generates business logic codes by programming and coding a URL from which the business logic will be fetched and the input and output parameters and SQL modified as described above and transfers the generated business logic codes to the application execution platform 40 at step S240.

In response thereto, the application execution platform 40 stores the received business logic codes in the metadata storage unit 50 as business logic dedicated to the tenant.

As described above, since each of tenants who have subscribed to service may configure business logic through the service configuration tool 20, each of the tenants may modify business logic in a desired form.

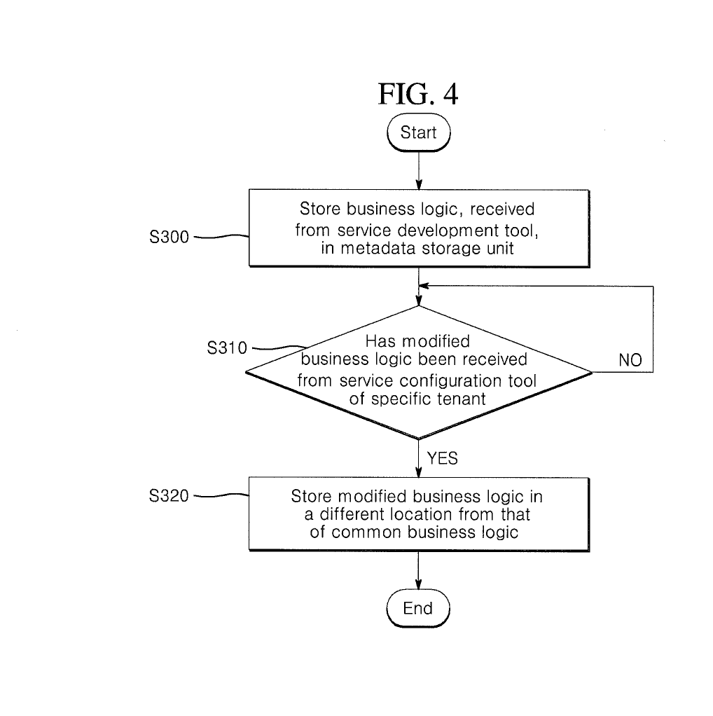

FIG. 4 is a flowchart illustrating an operation of the method of configuring business logic supporting multi-tenancy according to an embodiment of the present invention.

The application execution platform 40 stores business logic, received from the service development tool 10, in the metadata storage unit 50 as a common business logic at step S300.

Next, the application execution platform 40 determines whether a modified business logic is received from the service configuration tool 20 of a specific tenant at step S310.

If, as a result of the determination, the modified business logic is determined to have been received from the service configuration tool 20, the application execution platform 40 stores the modified business logic in a row different from that of the common business logic on the metadata storage unit 50 at step S320.

That is, the application execution platform 40 separately stores a common business logic and business logic dedicated to a specific tenant in order not to influence service provided to other tenants who have not modified their common business logics.

Furthermore, the application execution platform 40 may store the dedicated business logic of the specific tenant based on the tenant ID of the specific tenant.

For example, if a tenant ID using a common business logic is ‘0’ and the ID of a row where the common business logic is stored is ‘1’, a tenant ID using a modified business logic may be set as ‘100’, and the ID or a row where the modified business logic is stored may be set as ‘2’.

As described above, since business logic modified by a specific tenant and a common business logic developed by a developer are separately stored, each tenant may modify business logic without affecting service provided to other tenants even after service is distributed.

In accordance with the present invention, since a developer does not need to participate the configuration of business logic, a service provider can reduce maintenance and repair costs. Furthermore, the efficiency of resources can be increased because service can be provided to a plurality of tenants through one platform.

Furthermore, since each of tenants who have subscribed to service can configure business logic for application service through the service configuration tool, each tenant may modify and used business logic in a desired form.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A method of configuring business logic supporting multi-tenancy, comprising:
storing, by an application execution platform, business logic, received from a service development tool, in a metadata storage unit as a common business logic;
determining, by the application execution platform, whether a modified business logic has been received from a service configuration tool of a tenant; and
if the modified business logic is determined to have been received, storing, by the application execution platform, the modified business logic in the metadata storage unit as business logic dedicated to the tenant.

2. The method of claim 1, wherein in the storing of the modified business logic, the business logic dedicated to the tenant is stored separately from the common business logic.

3. The method of claim 2, wherein in the storing of the modified business logic, the business logic dedicated to the tenant is stored based on a tenant ID of the tenant.

4. The method of claim 1, further comprising, after the storing of the business logic dedicated to the tenant:
determining, by the application execution platform, whether service execution input to request an execution of service has been received from an application;
if the service execution input is determined to have been received, extracting, by the application execution platform, business logic from the metadata storage unit based on the service execution input; and
executing, by the application execution platform, the service by performing the extracted business logic.

5. The method of claim 4, wherein the service execution input includes a tenant ID of the tenant and a Uniform Resource Location (URL) for fetching the business logic stored in the metadata storage unit.

6. The method of claim 5, wherein in the extracting of the business logic from the metadata storage unit, the application execution platform extracts the common business logic or the business logic dedicated to the tenant based on the tenant ID.

7. The method of claim 5, wherein in the executing of the service by performing the extracted business logic, the application execution platform executes the service by querying an application database about a Structured Query Language (SQL) of the extracted business logic.
